(19) United States
(12) Patent Application Publication
(10) Pub. No.: US 2018/0033429 A1
(43) Pub. Date: Feb. 1, 2018

(54) EXTENDABLE VEHICLE SYSTEM

(71) Applicant: FORD GLOBAL TECHNOLOGIES, LLC, Dearborn, MI (US)

(72) Inventors: Omar MAKKE, Lyon Township, MI (US); Oleg Yurievitch GUSIKHIN, West Bloomfield, MI (US); Perry Robinson MacNEILLE, Lathrup Village, MI (US); Jeffrey YEUNG, Ann Arbor, MI (US); Dehua CUI, Northville, MI (US)

(21) Appl. No.: 15/219,416

(22) Filed: Jul. 26, 2016

(51) Int. Cl. G10L 15/22; B60R 16/023; G10L 15/02; G10L 15/30; G10L 15/00

(52) U.S. Cl. CPC G10L 15/22; G10L 15/30; G10L 15/005; G10L 15/02; B60R 16/023; G10L 2015/223

(57) ABSTRACT

A vehicle system includes a vehicle processor programmed to process a vehicle signal received from an in-vehicle sensor; and process an external signal received from an external sensor of a detectable external device. When connected to the external device, the processor performs a first function using the external signal, and when disconnected from the external device, the processor estimates the external signal to perform the first function and performs a second function.

### TECHNICAL FIELD

The present disclosure relates to an extendable vehicle system. More specifically, it relates to a vehicle system that can be extended by connecting to an external device.

### BACKGROUND

Infotainment systems, such as Ford SYNC®, may bring a number of features to a vehicle including navigation, telematics, and climate control. However, a full-featured infotainment system offering those functions may increase the cost of the vehicle. Vehicle purchasers who prefer to spend less money but still desire basic infotainment features may choose a low cost infotainment system. The low-cost infotainment option may be more economical due to being supported by other revenue sources such as advertising and/or may offer fewer features.

### SUMMARY

In one or more illustrative embodiments, a vehicle system includes a vehicle processor programmed to process a vehicle signal received from an onboard sensor; and process a device signal received from a sensor of a connected mobile device, wherein when connected to the mobile device, the processor performs a first function using the device signal, and when disconnected from the mobile device, the processor estimates the external signal to perform the first function and performs a second function.

The first function may include at least one of speech recognition, navigation, parallel computing, climate control, or mapping functions. The mobile device may be a smart phone. The mobile device may be connected to the processor via a wired connection. The mobile device may be connected to the processor using at least one of a universal serial bus (USB) connector or an on-board diagnostic II (OBD2) connector. The mobile device may be connected to the processor wirelessly. The mobile device may be connected to the processor using at least one of a BLUETOOTH connection or a Wi-Fi connection.

In one or more illustrative embodiments, a method for performing a function on a vehicle system includes loading a function specifying at least one parameter on which to operate from a memory to a processor of a vehicle, identifying an unavailable parameter based on the at least one parameter and information indicative of a hardware configuration of the vehicle, identifying an algorithm for generating an estimated parameter to replace the unavailable parameter, and performing the function using the estimated parameter despite the unavailable parameter.

The method may further include receiving at least one vehicle signal from at least one vehicle sensor by the processor, and comparing the at least one parameter and the at least one vehicle signal to identify the unavailable parameter. The method may further include aborting performing the function responsive to identifying that the estimated parameter cannot be generated.

In one or more illustrative embodiments, a vehicle system includes a processor of a vehicle, having speech recognition capabilities, configured to present, via an interface of the vehicle, options for an internal speech recognition mode and an external speech recognition mode performed via a connected mobile device, responsive to the internal speech recognition mode being selected, perform speech recognition using the computing platform, and responsive to the external speech recognition mode being selected, receive processed speech recognition data from the mobile device.

The external speech recognition mode may support languages unavailable for speech recognition using the internal speech recognition mode. The vehicle computing platform may be further configured to offer, via the interface, options for selection of a language for initial recognition of a spoken utterance, and attempt to match the utterance to a command using a grammar corresponding to the language for initial recognition before attempting to match the utterance to a command using a grammar corresponding to a language other than the language for initial recognition. The external speech recognition mode may use a grammar supporting additional commands that are not supported by a grammar of the computing platform used for the internal speech recognition mode. The mobile device may perform speech recognition by sending a spoken utterance to a remote computing system over a communication network, and receiving a result from the remote computing system indicative of a command included in the utterance.

In one or more illustrative embodiments, a system includes a processor of a vehicle, configured to query a connected mobile device for available hardware services of the mobile device, receive, from the mobile device, identifiers indicative of the available services, identify which identifiers correspond to services supported by the vehicle computing platform, send a list of the supported services to the mobile device, and allow for user selection of the supported services on a human-machine interface (HMI) of the vehicle.

The processor may be further configured to offer, via the HMI of the vehicle, options for an internal speech recognition mode and an external speech recognition mode performed via a supported service of the mobile device. Responsive to the internal speech recognition mode being selected, the vehicle computing platform may perform speech recognition using the computing platform. Responsive to the external speech recognition mode being selected, the vehicle computing platform may receive processed speech recognition data from the mobile device.

### BRIEF DESCRIPTION OF THE DRAWINGS

FIG. 1 illustrates an example extendable in-vehicle system of one embodiment of the present disclosure;

FIG. 2A illustrates an example of a portion of a vehicle having the in-vehicle system connected with the external device to perform a climate control function of one embodiment of the present disclosure;

FIG. 2B illustrates an alternative example of a portion of a vehicle having the in-vehicle system connected with the external device to perform a climate control function of one embodiment of the present disclosure;

FIG. 2C illustrates yet another alternative example of a portion of a vehicle having the in-vehicle system connected with the external device to perform a climate control function of one embodiment of the present disclosure;

FIG. 3 illustrates an example of a navigation function of the in-vehicle system of one embodiment of the present disclosure;

FIG. 4 illustrates an example of a speech recognition function of the in-vehicle system of one embodiment of the present disclosure;

FIG. 5 illustrates interfaces displaying options of utterance of one embodiment of the present disclosure;

FIG. 6 illustrates an example of the mobile device used in a stop-start system according to one embodiment of the present disclosure;

FIG. 7A illustrates a flow chart of a stop-start operation according to one embodiment of the present disclosure;

FIG. 7B illustrates a flow chart of a stop-start operation according to another embodiment of the present disclosure;

FIG. 7C illustrates a flow chart of a stop-start operation according to yet another embodiment of the present disclosure; and

FIG. 8 illustrates a data flow chart between the computing platform and the mobile device according to one embodiment of the present disclosure.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

A vehicle system may have capabilities that are manufactured into a vehicle and require vehicle power, size, thermal management, reliability, and access to analog signals from vehicle sensors. Components of the vehicle system may remain attached to the vehicle.

A mobile device may have features such as wireless communication, radio receivers, camera, microphone, speaker, sound processing, location sensing, magnetometer, accelerometer, and chemical and physical air sensing. These features may be provided by hardware components of the mobile device that are light, small, low-power, consumer robust, with low-bandwidth network requirements. These components may remain physically connected to the mobile device or connected to the mobile device via a network connection.

Many vehicle occupants bring their mobile devices into the vehicle cabin, where those devices are equipped with hardware features that provide services that are unavailable to the computing platform of the vehicle. Examples of such services may include a GPS, camera, temperature sensing, humidity sensing, barometric pressure sensing, air quality sensing, accelerometer sensors, magnetometer sensors, a wireless network interface adapter, a touch display and/or audio and video systems. These features may be utilized by the vehicle to provide additional functionality of an infotainment system that includes those services and hardware.

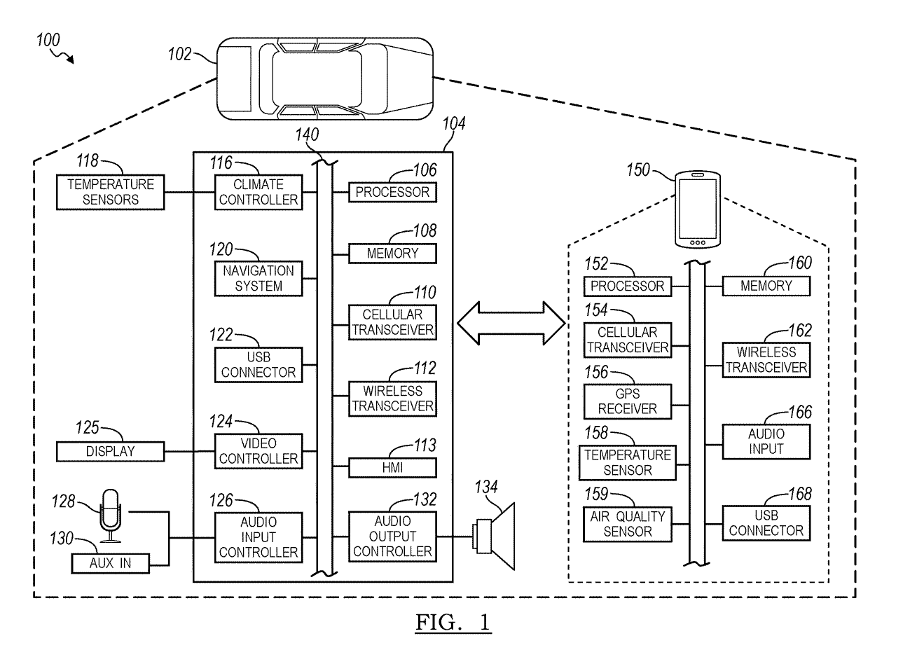

FIG. 1 illustrates an example diagram of an extendable in-vehicle system 100 installed in a vehicle 102. The vehicle 102 may be one of various types of passenger vehicles, such as a crossover utility vehicle (CUV), a sport utility vehicle (SUV), a truck, a recreational vehicle (RV), a boat, a plane or other mobile machine for transporting people and/or goods. A computing platform 104 is installed to the in-vehicle system 100. The computing platform 104 may include components such as a processor 106, a memory 108, a cellular transceiver 110, a wireless transceiver 112 (e.g., Wi-Fi transceiver and/or BLUETOOTH transceiver), a human-machine interface (HMI) 113, a climate controller 116 connected to a temperature sensor 118, a navigation system 120, a Universal Serial Bus (USB) connector 122, a video controller 124 connected to a display 125, an audio input controller 126 connected to a microphone 128 and an auxiliary input 130, and an audio output controller 132 connected to a speaker 134. Components of the computing platform 104 may be configured to communicate with each other via one or more in-vehicle networks 140. As a non-limiting example, the in-vehicle network 140 may allow the processor 106 to receive signals sent from the navigation system 120, and send signals to the video controller 124 for display to the display 125. The in-vehicle networks 140 may include one or more of a vehicle controller area network (CAN), a system bus, an Ethernet network, or a media oriented system transfer (MOST), as some examples. It should be noted that the modularization of the computing platform 104 is merely exemplary, and more, fewer, and/or different partitioned computing platform 104 devices may be used.

The computing platform 104 may be configured to communicate with a mobile device 150 of a vehicle occupant. The mobile device 150 may be any of various types of portable computing device, such as a cellular phone, a tablet computer, a smart watch, a laptop computer, a portable music player, or another device capable of communication with the computing platform 104. In an example, the mobile device 150 may include a processor 152, a cellular transceiver 154, a GPS receiver 156, a temperature sensor 158, a memory 160, a wireless transceiver 162, an audio input 166, and a USB connector 168. The computing platform 104 may be configured to communicate with a wireless transceiver 162 of the mobile device 150 that is compatible with the wireless transceiver 112 of the computing platform 104. Additionally or alternately, the computing platform 104 may be configured to communicate with the mobile device 150 over a wired connection, such as via a USB connection between a USB connector 168 of the mobile device 150 and the USB connector 122. In still other examples, the computing platform 104 may additionally or alternatively be configured to communicate with the mobile device 150 over other types of connections, such as via an On-Board Diagnostic II (OBD2) adapter connected to an OBD2 port of the vehicle 102 (not shown in FIG. 1).

When a mobile device 150 equipped with hardware components (e.g., the GPS receiver 156, and the temperature sensor 158 mentioned above) connects to the computing platform 104, the mobile device 150 may allow the computing platform 104 to use data from its hardware components to enhance the function of the computing platform 104. In one example, the computing platform 104 is configured to access the temperature sensor 158 of the mobile device 150 to obtain the temperature information around the mobile device 150. In another example, the computing platform 104 is configured to access the GPS receiver 156 to obtain more accurate position information of the mobile device 150 paired with the vehicle 102. It should be noted that these example hardware components of the mobile device 150 to enhance the function of the computing platform 104 are non-limiting, and more, fewer, and/or different hardware components may be used to provide services of the mobile device 150 for use by the computing platform 104.

The computing platform 104 may load a function specifying at least one parameter on which to operate from a memory to a processor. This function may include, for example, a climate control function or a navigation function. The computing platform 104 may identify an unavailable parameter based on the at least one parameter and information indicative of a hardware configuration of the vehicle. This unavailable parameter may include data from a climate control sensor or data related to the current global position of the vehicle. Lacking the unavailable parameter, the computing platform 104 may identify an algorithm for generating an estimated parameter to replace the unavailable parameter; and perform the function using the estimated parameter despite the unavailable parameter. Examples are described in detail in this disclosure.

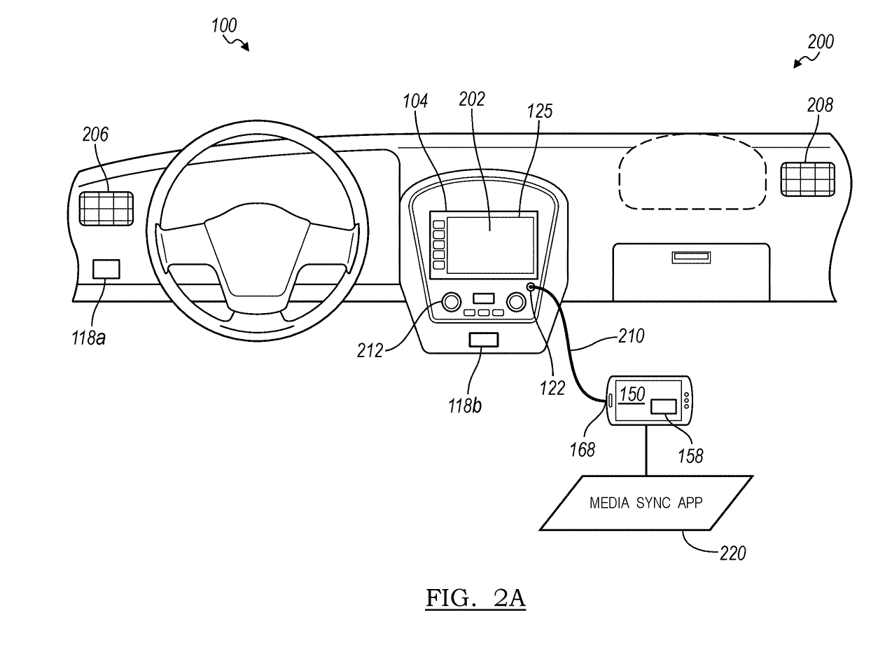

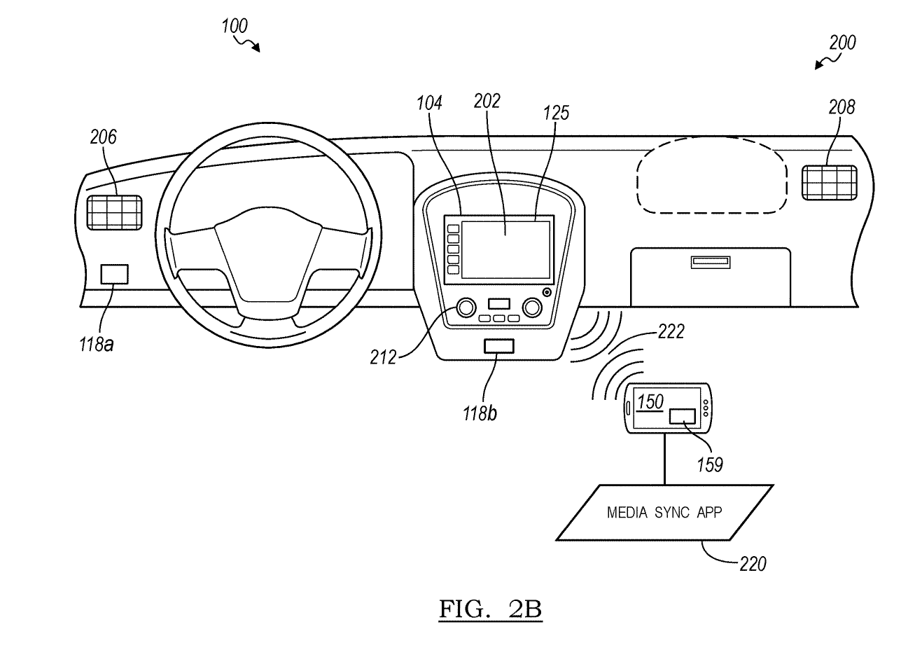

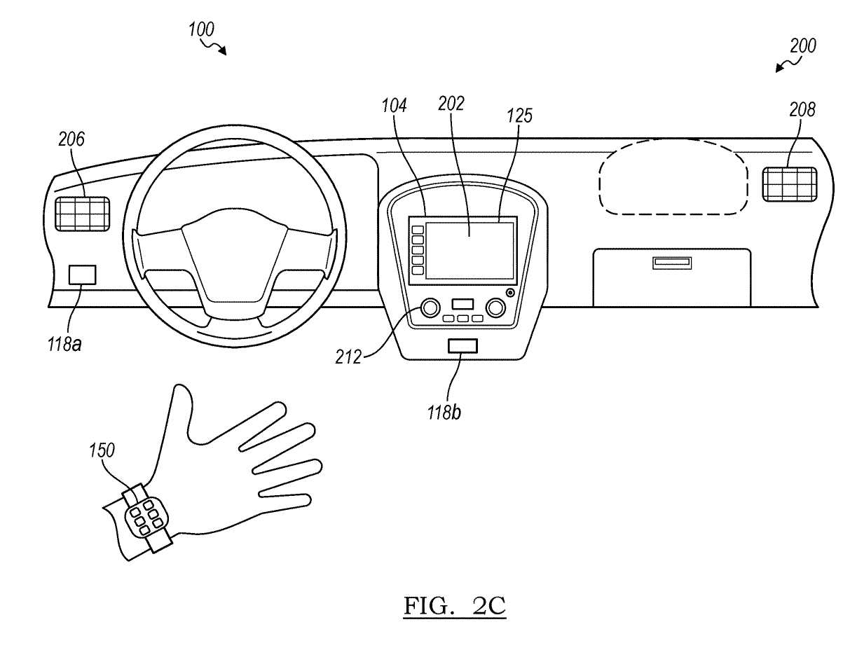

FIG. 2A illustrates an example 200 of a portion of the vehicle 102 having the in-vehicle system 100 connected with the mobile device 150 to perform a climate control function. As illustrated, an example in-vehicle system 100 uses two temperature sensors 118a, 118b to obtain the internal temperature of the cabin so as to operate the climate controller 116 correctly. Air vents 206, 208 are mounted on the dashboard to provide air of a desired temperature to the cabin (e.g., cool, hot, etc.). In the illustrated example, the first air vent 206 is located on the driver side to provide air to the driver and the second air vent 208 is located on the passenger side to provide air to the passenger. The occupants may adjust the temperature settings through an input device 212 and the temperature information may be displayed on the display 125 on a user interface 202. In one example, the user interface may be an HMI 133 configured to allow the occupant to interact with the vehicle 102. It should be noted that the layout of vents 206 and temperature sensors 118 is merely an example, and more, fewer, and differently laid out vents 206 and temperature sensors 118 may be used.

In one example, the first temperature sensor 118a is located about a driver side of the vehicle 102 to provide better temperature feedback for the driver of the vehicle 102, and the second temperature sensor 118b is located about a middle of the dashboard. In this example, since there is no sensor about the passenger side of the vehicle 102, temperature information relating to the passenger side may not be accurately obtained nor sent to the climate controller 116. The lack of accurate temperature data for the passenger side reduces the effectiveness of adjustments to the air temperature programmed to exit from the right air vent 208. Moreover, the lack of temperature data may be a further issue when the climate controller 116 is set to a dual-zone or multi-zone mode which allows different air vents to be separately controlled, as there may be no other temperature sensors 118 in the zone from which to receive data.

The climate controller 116 may be configured to estimate the temperature on the passenger side using the data sent from the first temperature sensor 118a and the second temperature sensor 118b to control the right air vent 208. In one example, the computing platform 104 estimates the temperature on the passenger side by averaging the temperature data sent by the first temperature sensor 118a and the same by the second temperature sensor 118b. For instance, if the data sent from the first temperature sensor 118a and the second temperature sensor 118b indicates temperatures of 80° F. and 86° F. respectively, the computing platform 104 estimates the passenger side temperature to be 83° F. and controls the right air vent 208 accordingly. Alternatively, when the second temperature sensor 118b located in the middle of the dashboard senses a higher temperature than the first temperature sensor 118a located on the driver side, it is reasonable to infer that the passenger side is hotter because of the proximity of the second temperature sensor 118b. Therefore, the passenger side temperature may be estimated according to the following equation: t_{passenger}=2t_{118b}−t₁₁₈ₐ. Using the numbers from the above example, the estimation of the passenger side temperature would be 92° F. It is to be noted that when the vehicle 102 is equipped with more than two temperature sensors, similar estimations may be performed although with additional terms for each additional sensor.

Although the passenger temperature may be estimated by method set forth above, it may be inaccurate in some cases, as mentioned above. As illustrated in FIG. 2A, the climate control of vehicle 102 may be improved by using the temperature data sent by temperature sensor 158 of the mobile device 150. As an example, the computing platform 104 includes a SYNC APPLINK® component of the SYNC® system provided by The Ford Motor Company, and the mobile device 150 is configured to communicate with the computing platform 104 via SYNC through a SYNC-compatible media synchronization application 220 executed by the mobile device 150. As transport for the communication, the USB connector 168 of the mobile device 150 is connected to the USB connector 122 of the computing platform 104 via a cable 210. (Alternatively, the mobile device 150 may be connected to the computing platform 104 wirelessly through the wireless transceiver 112 which may include BLUETOOTH, and/or Wi-Fi components.) The mobile device 150 may be placed about the passenger side of the vehicle 102 such that the temperature sensor 158 of the mobile device 150 may obtain temperature information on the passenger side. This information may be forwarded to the computing platform 104 via the media synchronization application 220. Accordingly, the computing platform 104 may obtain the actual temperature of the passenger side so as to operate the climate controller 116 more accurately. Alternatively, the mobile device 150 may be placed elsewhere within the vehicle 102 cabin, such as about the back seat, to obtain the temperature data related to conditions in that location. To facilitate understanding of the temperature data from the mobile device 150, the computing platform 104 may be configured to allow the occupants of the vehicle 102 to indicate where the mobile device 150 is placed within the vehicle 102 via the user interface 202 displayed on the display 125.

FIG. 2B illustrates another example 200 of a portion of a vehicle 102 having the in-vehicle system 100 connected with the mobile device 150 to perform a climate control function. In this example, the vehicle 102 is not equipped with a built-in air quality sensor, but instead is configured to use the air quality sensor 159 of the connected mobile device 150 to inform the climate control system of cabin air quality. In an example, the mobile device 150 is connected to the computing platform 104 via wireless connection 222 which may be a BLUETOOTH or a Wi-Fi connection that is supported by both the wireless transceiver 112 of the computing platform 104 and the wireless transceiver 162 of the mobile device 150. Similar to the previous example, the computing platform 104 includes a SYNC APPLINK® component of the SYNC® system provided by The Ford Motor Company, and the mobile device 150 is configured to communicate with the computing platform 104 through a media synchronization application 220. The mobile device 150 is configured to obtain the cabin air quality data using its air quality sensor 159 and send the data to the computing platform 104. In a hot summer scenario example, the climate system in vehicle 102 is in recirculation mode, preventing warm air from the outside coming into the cabin so that the cabin temperature remains comfortable for the occupants. The air quality sensor 159 may sense the carbon-dioxide (CO₂) level in the cabin of the vehicle 102. When the CO₂ level reaches a certain threshold, the computing platform 104 may turn off recirculation to allow fresh air into the cabin. When the CO₂ level drops, the computing platform 104 may control the climate system to again switch to the recirculation mode to keep the cabin temperature maximally low.

In another example, the air quality sensor 159 may be more complex and able to detect other parameters such as pollen and/or dust level. The computing platform 104 may be configured to notify the user via the user interface 202 to check or replace the cabin air filter upon certain conditions being met. These conditions may include, for instance, the pollen and/or dust level in the cabin exceeding a threshold level for more than a predefined period of time, which may indicate that filtration function of the filter has reached capacity.

In yet another example, the air quality sensor 159 may be a device separate from the mobile device 150 and positioned within the cabin. For instance, the air quality sensor 159 may be an aftermarket component that is unable to communicate with the computing platform 104 without the aid of the mobile device 150. During operation, the mobile device 150 may be configured to communicate between the air quality sensor 159 and the computing platform 104 by wired and/or wireless connection, and send air quality data that is obtained by the air quality sensor 159 to the computing platform 104.

When disconnected from the mobile device 150, the computing platform 104 may be configured to identify that there is no air quality sensor 159 available. For instance, the computing platform 104 may listen for data from an air quality sensor 159 via a vehicle bus, such that if no information is received within a predetermined period of time, e.g., one minute, five minutes, etc., the vehicle 102 determines that there is no air quality sensor 159 available. Responsive to determining that there is no air quality sensor 159 available, the vehicle 102 may generate an estimated value indicative of the air quality within the vehicle 102. For instance, the vehicle 102 may estimate the cabin air quality as a decreasing value based on a measure of how long the recirculation setting has been applied. This may cause the vehicle 102 to turn on/off the recirculation on a time interval basis (e.g., periodically every 5 minutes). Alternatively, the computing platform 104 may be configured to estimate a parameter to use in place of air quality sensor 159 by the cabin temperature, such as when the actual cabin temperature is within a threshold of the preset desired temperature, the climate control system enters into the fresh air mode; otherwise, climate control system switches to the recirculation mode.

FIG. 2C illustrates yet another example 200 of a portion of a vehicle 102 having the in-vehicle system 100 connected with the mobile device 150 to perform a climate control function. In this example, the mobile device 150 is a wearable device, such as a smart watch strapped onto an occupant's wrist, able to detect the occupant's body temperature. In an example, the mobile device 150 may be an Apple Watch® provided by Apple Inc. of Cupertino, Calif. The mobile device 150 may be wirelessly connected to the computing platform 104 using its wireless transceiver 162. In an example, the computing platform 104 includes a SYNC APPLINK® component of the SYNC® system provided by The Ford Motor Company, and the mobile device 150 is configured to communicate with the computing platform 104 through a media synchronization application installed to the mobile device 150. The mobile device 150 is equipped with skin temperature sensors (not shown) that are able to detect the body temperature of the occupant. A non-limiting example skin temperature sensor is the LMT70 temperature sensor provided by Texas Instruments of Dallas, Tex. In a hot summer scenario example, when the mobile device 150 detects the occupant's body temperature is increasing indicating the occupant feels hot, the climate controller 116 of the computing platform 104 may increase the A/C cooling performed by the vehicle 102 by lowering the output air temperature and/or increasing the fan speed. Additionally or alternatively, the climate controller 116 may switch to the Max A/C mode (e.g., in which the fan is turned to maximum speed, the output air temperature is set to the lowest temperature, and recirculation is turned on) until the mobile device 150 detects the occupant's body temperature drops (e.g., back to around 36.8° C. (98.2° F.) where most people feel comfortable), at which point the climate controller 116 switches to a less aggressive cooling setting (e.g., by lowering the fan speed and/or raising the output air temperature). It is noted that in this example the occupant's body temperature detected by the mobile device 150 is not the only parameter that may be used by the climate controller 116 to control the climate system, and other data such as the cabin temperature detected by the temperature sensor 118 may also be utilized by the climate controller 116 in determining the air output settings.

When disconnected from the mobile device 150 in this example, the computing platform 104 may lack data indicative of the body temperature of the user. Thus, when not connected to the mobile device 150, the climate controller 116 may control the climate system using an estimated parameter of cabin temperature in place of body temperature. As an example, in a hot summer scenario when the cabin temperature sensor 118 detects the cabin having cooled down to a preset temperature such as 22° C. (72° F.) while the outside temperature is around 29° C. (85° F.), the climate controller 116 reduces the amount of cooling being provided to maintain the preset temperature, independent of body temperature.

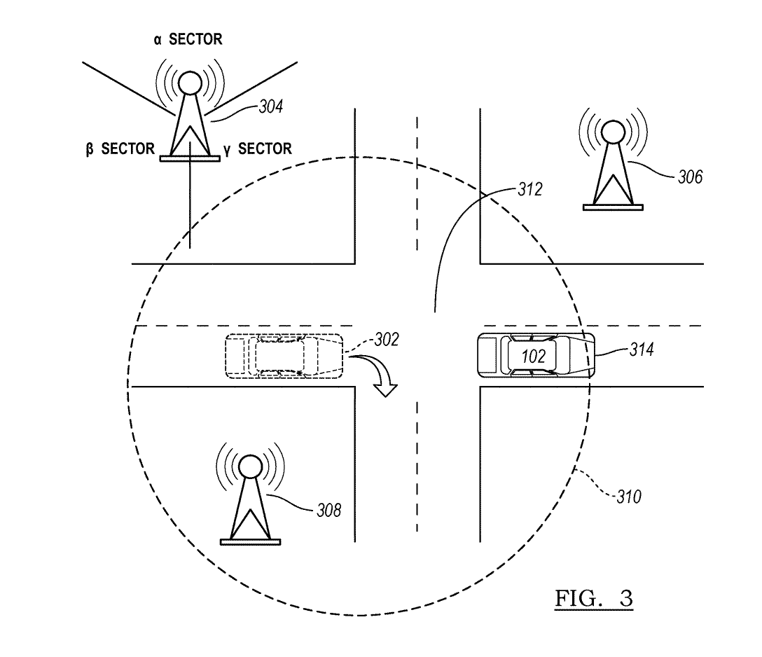

FIG. 3 illustrates an example 300 of a navigation function of the in-vehicle system 100. In this example, the computing platform 104 includes the navigation system 120 and the cellular transceiver 110, but not a GPS receiver. During operation, as GPS position parameter data is unavailable, the navigation system generates an estimated parameter for the position of the vehicle 102 using cellular tower-based positioning methods such as cellular tower triangulation. As illustrated in the example 300, the vehicle 102 has three cellular towers 304, 306, 308 nearby. The cellular transceiver emits roaming signals to all of these three cellular towers 304, 306, 308. Taking the cellular tower 304 for instance, the coverage of cellular tower 304 is divided into 3 sectors: the α sector, the β sector, and the γ sector, and each sector covers about 120°. In the present example, the vehicle 102 is in the γ sector. By measuring signal strength and the round-trip signal time of the cellular transceiver 110, an approximate distance between the vehicle 102 and the cellular tower 304 can be measured. When that distance is combined with the orientation of the γ sector, an approximate position of the vehicle 102 can be obtained. The approximate position of the vehicle 102 can be improved when the cellular transceiver 110 is connected to multiple cellular towers simultaneously. In the present example, the cellular transceiver 110 is also connected to cellular towers 306 and 308, and by using the same methods the approximate position of the vehicle 102 determined by cellular towers 306 and 308 can be obtained. In one example, the overlap of the approximate positions determined by the three cellular towers 304, 306, 308 may be used as the approximate area 310 that the vehicle 102 may possibly be in. However, in some cases, the overlapped area may be large, such as a one square mile area. As one possible approximation, the navigation system 120 may assume the vehicle 102 is at the center of the approximate area 310 to perform the navigation. However, due to this potential lack of precision, the navigation system 120 may instruct the driver to turn right at intersection 312 assuming the vehicle 102 is at position 302, when, in fact, the vehicle 102 has already passed the intersection 312 at position 314, although it is within the approximate area 310.

By receiving position data from a mobile device 150 that includes a GPS receiver 156, the functioning of the navigation system 120 may be improved. The mobile device 150 may be configured to connect to the computing platform 104 to allow it to access the GPS receiver 156 of the mobile device 150 to obtain a current position information parameter for the mobile device 150. Since the mobile device 150 is inside the vehicle 102 cabin or otherwise close to the vehicle 102, the computing platform 104 may use the mobile device 150 position as the vehicle 102 position to perform the navigation. Once connected to the mobile device 150, the navigation system 120 of the computing platform 104 may use the location signal from the GPS receiver 156 in lieu of the estimation of the vehicle 102 location, or alternatively use the location signal from the GPS receiver 156 in combination with the estimation.

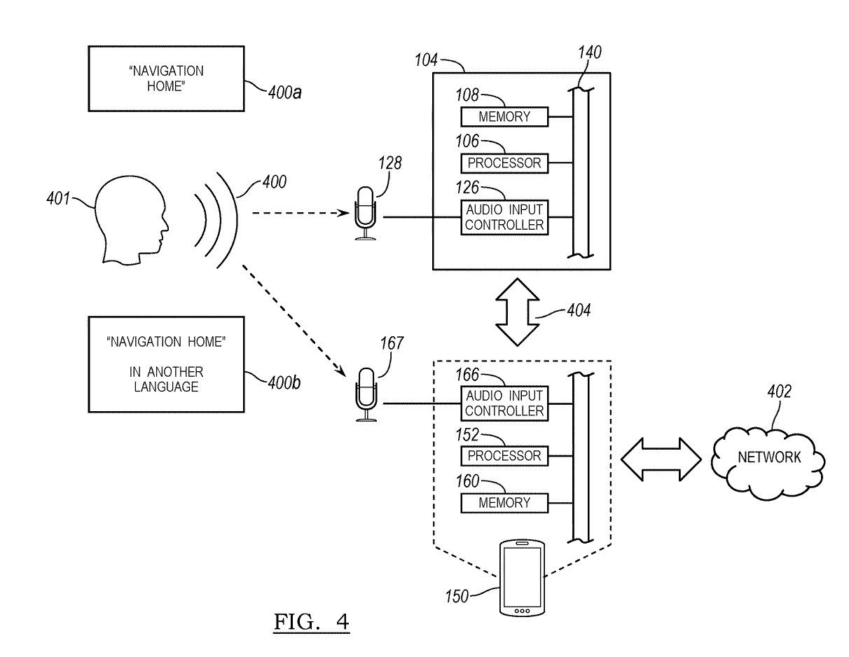

FIG. 4 illustrates an example 400 of a speech recognition function of the in-vehicle system of one embodiment of the present disclosure. In the present disclosure, the terms voice command, spoken command, and utterance may be used interchangeably. The term spoken recognition may refer to single word or phrase recognition and/or large vocabulary continuous speech recognition (LVCSR). Under the single word or phrase recognition, an utterance is received and converted into a string of phonetic symbols. This string may be compared to the keys in an associative array of keys and actions in which the keys may be phonetic strings that correspond to the specific utterances that are understood by the recognizer. This matching may result in a miss or an n-best list of the best matches. Further processing can reduce the n-best list to a single utterance, or, if there is a miss, a misrecognition strategy can be employed. Utterances can be dynamically added to the table by first converting the utterance into a phonetic string, then adding it and its associated action into the associate array. The LVSCR may accept utterances that are sentences or even paragraphs. The utterances may be indexed by complex data structures that utilize language structures to aid the recognition. For a word recognition approach, the language being spoken is less important than it is for LVCSR, where language structure may be relevant to the recognition.

In the embodiment illustrated in FIG. 4, an infotainment system may include speech recognition and navigation functions. A user 401 may utter a spoken command 400 such as a “navigate home” utterance 400a in English. The microphone 128 connected to the audio input controller 126 may capture the utterance 400a and send it to the processor 106 for processing. The processor 106 analyzes the utterance 400a by comparing it with utterances stored in memory 108. If a match is found, the processor 106 performs an action corresponding to the recognized command, which, in this case, is to start route guidance home. If no match is found, the computing platform 104 may notify the user by audio and/or video indications. Alternatively, the computing platform 104 may ask the user to repeat the utterance to improve the recognition confidence. Or, the computing platform 104 may also ask the user if he or she would like to add an utterance and its associated action to the list of utterances stored in memory 108. In some systems, a reduced set of sample utterances may be stored in memory 108, as compared to a more full-featured recognition system utilizing services of a remote server, due to limited storage capacity in the vehicle 102.

The user may customize the speech recognition settings and add his or her own utterance to the stored utterances. In addition, the pre-installed utterances stored in memory 108 may be configured to a limited set of popular languages, e.g., English and Spanish. Therefore, if the user does not speak any of the pre-installed languages, that user may be unable to utilize the spoken command recognition functionality. For example, if the user's 401 spoken command 400b is “navigate home” in another language, such as French (perhaps “rentre chez moi”), the computing platform 104 may not recognize the command. It should be noted that utterances may be stored in various ways. In an example, a system may utilize word-level recognition to break utterances into words, syllables, and/or phonemes. As a more specific example, language may be broken down into a sequence of phonetic symbols such as those in the International Phonetic Alphabet (IPA). New utterances may be processed into IPA sequences that can be matched with sequences already in the database using a metric such as graph edit distance. Such matching of utterances may be language-independent. Knowing the language in advance may help the process of conversion of sounds into a symbolic language by allowing the phonotactics of the language to be used in the conversion.

A mobile device 150 connected to the computing platform 104 may be used to provide for additional language recognition functionality. In one example, the mobile device 150 may be a smart phone. The mobile device 150 is connected to the computing platform 104 through a link 404. Upon the detection of the mobile device 150 which supports the speech recognition function, the computing platform 104 may ask the user 401 to select which device he/she would like to use to perform the speech recognition function.

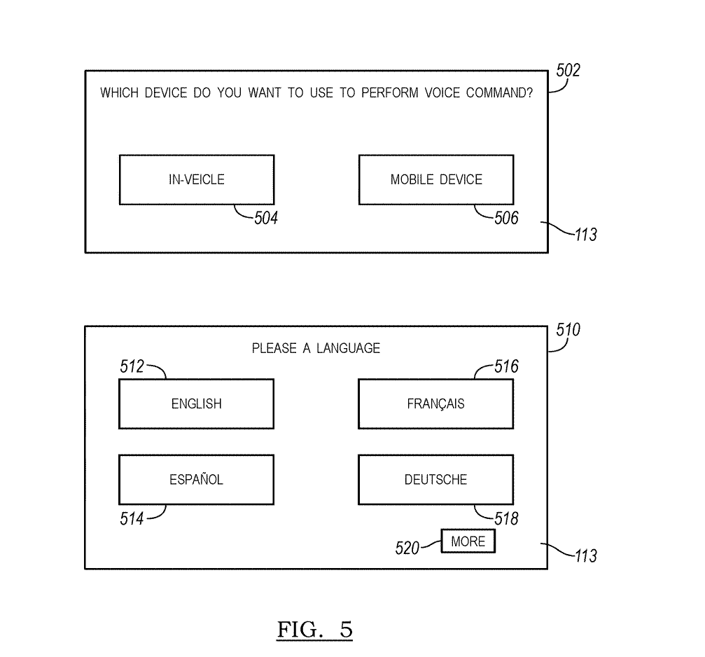

In one example, as illustrated in FIG. 5, the computing platform 104 is configured to use the HMI 113 to ask the user 401 to select a language by selection of one of buttons 504 or 506 displayed in option screen 502. As an example, the HMI 113 is a touch screen. The user 401 may prefer not to use the mobile device 150 to perform the speech recognition function by pushing the in-vehicle button 504, in which case the computing platform 104 performs the function as if the mobile device 150 is not connected. If, however, the user 401 pushes the Mobile Device button 506, the computing platform 104 may further ask the user 401 to select the language that he/she wants to use in option screen 510. As an example, four option buttons are displayed in the option screen 510, providing for receipt of user selection of one of English 512, Espanol (Spanish) 514, Francais (French) 516, and Deutsche (German) 518. Each language name is displayed in its own language in this example, although this is not required. More options may be provided by pushing the More button 520. It is noted that if the in-vehicle mode supports multiple languages, an option screen may be displayed allowing the user 401 to choose the language.

It is noted that in some embodiments, initial setup via the option screens 502, 510 may not be necessary, and the computing platform 104 may perform the speech recognition as a default. If the computing platform 104 is unable to recognize the command, however, the computing platform 104 may direct the mobile device 150 to attempt to perform the speech recognition. This can be performed by the computing platform 104 sending the captured spoken command 400 audio to the mobile device 150, or alternatively, a microphone 167 of the mobile device 150 may capture the spoken command 400 as the command is captured by the vehicle 102 but without processing the command unless a request from the computing platform 104 is received. If recognition of spoken commands in multiple languages is supported, the computing platform 104 or the mobile device 150 may try to recognize the command 400 by using the language grammars in a specific order. For example, the computing platform 104 and the mobile device 150 may first try to find a match to a command in an English grammar, and if the match fails, then try to find a match using a Spanish grammar.

For illustration purposes, the user 401 pushes the English button 512 to select English in option screen 510. As shown in FIG. 4, the microphone 167 of the mobile device 150 is configured to receive the spoken command or utterance 400a and send it to the processor 152 for analysis. The processor 152 analyzes the spoken utterance 400a by comparing it with speech commands of a grammar stored in memory 160. If a match is found, the mobile device 150 may send the result to the computing platform 104 to perform the corresponding function, which in this case is to start navigation to home. If a no match is found, the computing platform 104 may notify the user by audio and/or video. It is noted that the memory 160 of the mobile device 150 may store command recognition grammars with greater complexity or in additional languages than are stored in the memory 108 of the computing platform 104 because of the relatively greater storage capacity and relative ease of updating. In one example, the memory 160 may store grammar for recognizing speech commands that are not originally stored in the memory 108 of the computing platform when the car is manufactured, therefore the mobile device 150 performs a better speech recognition function. In one example, if the mobile device 150 fails to recognize the spoken command 400 that it receives, it may send the command 400 over the network 402 (such as the Internet) to a server to further analyze the command 400. If the network analysis is successful, the mobile device 150 may receive the result of the speech recognition and send the result to the computing platform 104.

In one example, there may be different strategies used for speech recognition that may influence the types of utterances that can be recognized. These strategies may include, for instance, word recognition, word spotting, and/or LVCSR. As an example, using a word recognition strategy, the user may utter a sequence of commands, each separated by a chime or other prompt given by the spoken dialog system, e.g., “navigator->points of interest->home->route->current location-start.” An utterance would be “navigator” or “home”. The utterances may be stored as sequences of phonetic symbols. In the LVCSR case, the user may say: “Start navigating me back home” or, equivalently, “Please begin routing me home.” In this case, the utterances may be stored as formal grammars.

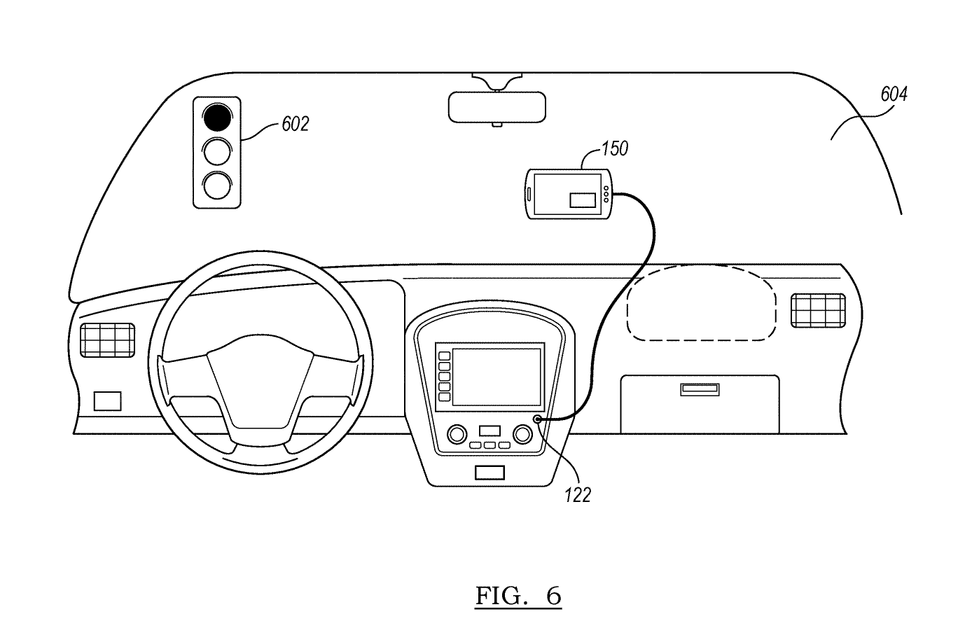

FIG. 6 illustrates an example 600 of the mobile device 150 used in a stop-start system according to one embodiment of the present disclosure. A stop-start system may be configured to use a strategy to selectively turn off a vehicle 102 engine when there is no demand for the engine, such as when the brakes are being pressed. Accordingly, a start-stop system may use data inputs such as a brake pedal to determine when to restart the engine in a vehicle 102 with automatic transmission. For instance, when the vehicle 102 stops before a traffic light, the engine may be turned off to conserve fuel. The engine may be restored when the traffic light turns green, followed by the system detection of the driver lifting off the brake pedal indicating the driver intends to resume movement of the vehicle 102. This system, however, suffers from a lag between lifting the brake and the vehicle 102 being ready to proceed due the time required to restart and stabilize the engine functioning.

As illustrated in the example 600, the mobile device 150 is connected to the computing platform 104 via the USB connector 122, and the computing platform 104 in turn communicates with the stop-start system (not shown) of the vehicle 102. The mobile device 150 may be placed on the windshield 604 of the vehicle 102 with its camera (not shown) facing forward so as to capture an image of traffic ahead of the vehicle 102. The camera may be unused when the vehicle 102 is running and/or the stop-start system is deactivated. When the stop-start system is active and the vehicle 102 stops at a traffic light, the engine of the vehicle 102 may be shut down by the system according to the start-stop strategy. Responsive to the stop condition, the computing platform 104 may send an activation signal to the mobile device 150. Responsive to receiving the activation signal, the mobile device 150 may switch on the camera to initiate capture of images of the forward path.

As an example illustrated in FIG. 6, the vehicle 102 stops at a traffic light 602 and the mobile device 150 captures an image of the traffic light 602 using the camera. Image processing software may be pre-installed on the mobile device 150, such that responsive to receiving the activation signal from the computing platform 104, the software may start to analyze the image captured by the camera to detect a trigger event. In this example, the trigger event may be the traffic light 602 turning green. Responsive to the trigger event being detected, the mobile device 150 may send an engine start signal to the computing platform 104, which may in turn forward the signal to the stop-start system to start the engine. Accordingly, the engine of the vehicle 102 may be started before the driver lifts the brake, therefore allowing more time for the engine to start and stabilize. As the engine is started earlier using this approach as compared to relying on brake pedal input, the lag between the driver lifting the brake and pushing the throttle to accelerate is reduced or even removed.

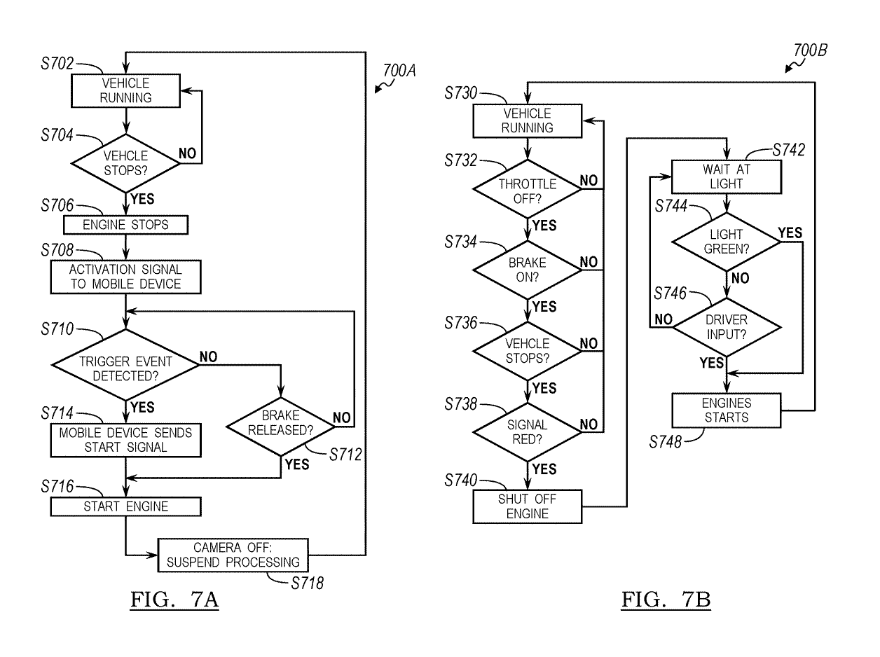

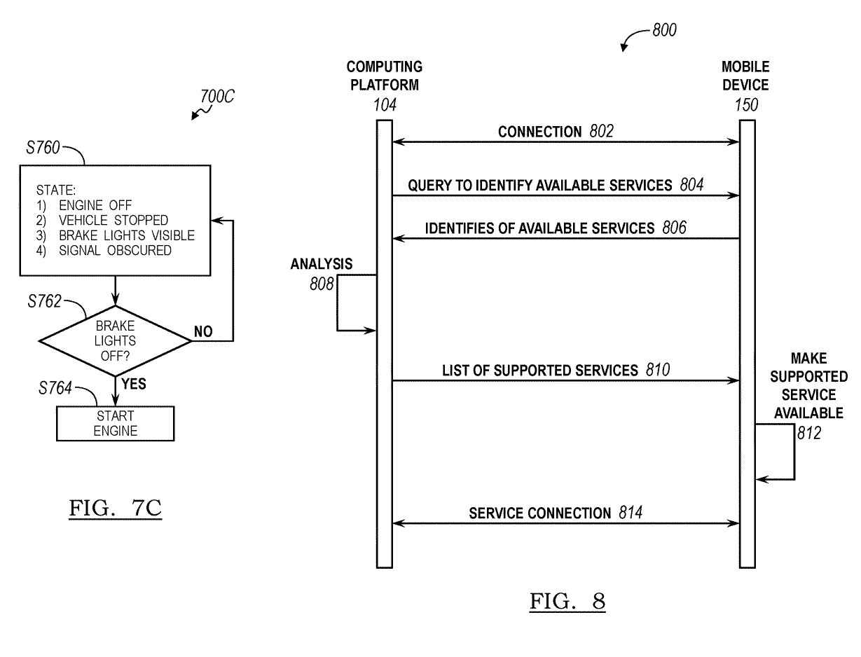

FIG. 7A illustrates a flow chart 700A of an example operation of a stop-start system according to one aspect of the present disclosure. While the stop-start system is switched on, the engine runs S702 until the vehicle 102 comes to a full stop S704. Upon the detection of the vehicle 102 stop, the engine may be turned off S704. A time threshold may be set into the system. For instance, the engine may turn off if the vehicle 102 is stopped for more than a predetermined period of time, such as three seconds, to prevent unintended engine stop when the vehicle 102 stops at a stop sign and the driver intends to resume moving shortly. Responsive to the engine stop S706 being triggered, an activation signal is sent to the mobile device 150 to activate a camera of the mobile device 150 and to initiate processing of images from the camera S708. If a trigger event, such as the traffic light turning green, is detected S710, the mobile device 150 may send an engine start signal to the stop-start system S714, notifying the vehicle 102 to restart the engine. If, however, the trigger event is not detected and the driver lifts the brake pedal indicating intention to resume movement S712, the system may start the engine S716 without receiving the engine start signal input from the mobile device 150. Responsive to the engine being started S716, the system may send a signal to the mobile device notifying it to deactivate the camera and suspend the image processing S718. Then the process goes back to S702 to wait for the next stop.

FIG. 7B illustrates a flow chart 700B of an example operation of a stop-start system according to another aspect of the present disclosure. While the vehicle 102 is running S730, the stop-start system monitors whether the driver lifts his or her foot from the throttle pedal S732. If the throttle pedal is still pressed, indicating the driver intends to continue driving movement, the process returns to S730 and continues monitoring the throttle input. Responsive to the driver lifting his or her foot from the throttle indicating an intention to decelerate, the stop-start system monitors whether the brake pedal is pressed S734. Responsive to the brake on signal being detected and the vehicle 102 coming to a complete stop S736, the stop-start system receives input from the mobile device 150 to detect a red light signal S738. It is noted that S736 may not be necessary, at least in some examples, such as when used on a hybrid vehicle 102. If a red light signal is detected, the stop-start system shuts off the engine S740 and waits at the traffic stop S742. If a green light signal is detected S744, the stop-start system restarts the engine S748 to cause the vehicle 102 to be ready to drive. If no green light is detected, driver inputs S746 such as lifting the brake pedal or pressing the throttle pedal may override the traffic light signal detection and start the engine S748.

It should be noted that the above illustration is merely an example. In another example, responsive to the vehicle 102 being stuck in traffic and the traffic light being out of visual range of the camera of the mobile device 150, the image processing software may detect the trigger event by determining the vehicle 102 ahead has its brake light turned off and/or moves forward, which may indicate the traffic resuming movement. In yet another example, the mobile device 150 may include a proximity sensor configured to detect distance from the vehicle 102 ahead, and may send the start engine signal when an increase of the distance is detected. In some examples, the image processing software may be installed on the computing platform 104 and the mobile device 150 may be configured to send the image data captured by the device camera to the computing platform 104 for processing.

FIG. 7C illustrates a flow chart 700C of an example a stop-start operation according to another embodiment of the present disclosure while the traffic light is obscured. In examples in which a vehicle 102 stops in traffic and the traffic light is obscured by the vehicle 102 ahead, the stop-start system may use the brake light signal of the vehicle 102 ahead to control the engine start S760. When the vehicle 102 ahead lifts off the brake and its brake light signal is off S762, the stop-start system may start the engine S764 because it indicates that the traffic is to resume movement shortly.

FIG. 8 illustrates a data flow chart 800 between the computing platform 104 and the mobile device 150 to establish a service connection according to one embodiment of the present disclosure. A service connection may allow occupants of the vehicle 102 to access the services of the mobile device 150 from the HMI 113 or other interface of the computing platform 104. A service connection may be established when a mobile device 150, such as a smart phone, is connected to a vehicle 102 the first time. This may occur when either the mobile device 150 and/or the vehicle 102 is new to the user. Alternatively, when mobile device 150 and/or the computing platform 104 is updated or has new software installed, an updated service connection may be established. As illustrated in the data flow chart 800, the mobile device 150 connects to the computing platform 104 via a connection 802. The connection 802 may be wired or wireless communication, such as discussed above. In an example, the computing platform 104 includes a SYNC APPLINK® component of the SYNC® system provided by The Ford Motor Company, and the mobile device 150 is configured to communicate with the computing platform 104 through a media synchronization application that is installed to the mobile device 150. The computing platform 104 may send a query 804 to the mobile device 150 requesting that the mobile device 150 identify services that are available on the mobile device 150. If the mobile device 150 fails to respond within a predefined period of time, such as one minute, the process may terminate. If the mobile device 150 supports the query, the mobile device 150 may send identifiers of each of the available services 806 to the computing platform 104. Upon receiving the identifiers, the computing platform 104 may analyze 808 the identifiers to determine among those available services, which one(s) may be supported by the computing platform 104. Responsive to the determination of which services of the mobile device 150 are compatible with the computing platform 104, the computing platform 104 may send a list of the identifiers of the supported services 810 to the mobile device 150. Accordingly, the mobile device 150 may make those supported services on the list available to the computing platform 104. Thus, a service connection 814 may be established between the computing platform 104 and the mobile device 150 in support of the supported services. Occupants of the vehicle 102 may accordingly access those supported services of the mobile device 150 from the HMI 113 or interface of the computing platform 104.

As an example, the mobile device 150 has three services available including air quality sensing, navigation location support, and a video game. The identifiers of those available services 806 may include names of the services, and/or their software and hardware requirements. Responsive to analyzing the identifiers, the computing platform 104 analyzes 808 that it meets the requirements for use of the air quality sensing and navigation services of the mobile device 150, but not the hardware requirements for the game (e.g., lack of a multi-touch screen). Responsive to the determination, the computing platform 104 sends a list of the supported services 810 to the mobile device 150, where the list includes the air quality sensing and the navigation services. Through this negotiation, the computing platform 104 may be configured to access those two services through the service connection 814, but not other services with which the vehicle 102 is not compatible.

In another example, the user of the mobile device 150 may configure which services of the mobile device 150 are to be made available to the vehicle 102. For instance, the user may not desire the computing platform 104 to have access to phone contacts on the mobile device 150 due to privacy reasons. Thus, the user may configure the contacts service to be a service unavailable to the computing platform 104. In yet another example, the identifiers of the available services 806 may only include a name or an identifier code of the services, and the computing platform 104 may utilize a database of application names and/or identifier codes to determine the requirements of the services and/or whether the computing platform 104 supports the service.

Computing devices described herein generally include computer-executable instructions where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, C#, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A vehicle system comprising:
a vehicle processor programmed to
process a vehicle signal received from an onboard sensor; and
process a device signal received from a sensor of a connected mobile device,
wherein when connected to the mobile device, the processor performs a first function using the device signal, and when disconnected from the mobile device, the processor estimates the external signal to perform the first function and performs a second function.

2. The vehicle system of claim 1, wherein the first function includes at least one of speech recognition, navigation, parallel computing, climate control, or telematics.

3. The vehicle system of claim 1, wherein the mobile device is a smart phone.

4. The vehicle system of claim 1, wherein the mobile device is connected to the processor via a wired connection.

5. The vehicle system of claim 4, wherein the mobile device is connected to the processor using at least one of a universal serial bus (USB) connector, or an on-board diagnostic II (OBD2) connector.

6. The vehicle system of claim 1, wherein the mobile device is connected to the processor wirelessly.

7. The vehicle system of claim 6, wherein the mobile device is connected to the processor using at least one of a BLUETOOTH connection or a Wi-Fi connection.

8. A method comprising:
loading a function specifying at least one parameter on which to operate from a memory to a processor of a vehicle;
identifying an unavailable parameter based on the at least one parameter and information indicative of a hardware configuration of the vehicle;
identifying an algorithm for generating an estimated parameter to replace the unavailable parameter; and
performing the function using the estimated parameter despite the unavailable parameter.

9. The method of claim 8, further comprising:
receiving at least one vehicle signal from at least one vehicle sensor by the processor; and
comparing the at least one parameter and the at least one vehicle signal to identify the unavailable parameter.

10. The method of claim 8, further comprising aborting performing the function responsive to identifying that the estimated parameter cannot be generated.

11. The method of claim 8, wherein the estimated parameter is generated based on at least one vehicle signal received over a vehicle bus.

12. A system comprising:
a processor of a vehicle, having speech recognition capabilities, configured to
present, via an interface of the vehicle, options for an internal speech recognition mode and an external speech recognition mode performed via a connected mobile device;
responsive to the internal speech recognition mode being selected, perform speech recognition using the computing platform; and
responsive to the external speech recognition mode being selected, receive processed speech recognition data from the mobile device.

13. The system of claim 12, wherein the external speech recognition mode supports languages unavailable for speech recognition using the internal speech recognition mode.

14. The system of claim 13, wherein the processor is further configured to offer, via the interface, options for selection of a language for initial recognition of a spoken utterance; and attempt to match the utterance to a command using a grammar corresponding to the language for initial recognition before attempting to match the utterance to a command using a grammar corresponding to a language other than the language for initial recognition.

15. The system of claim 12, wherein the external speech recognition mode uses a grammar supporting additional commands that are not supported by a grammar of the computing platform used for the internal speech recognition mode.

16. The system of claim 12, wherein the mobile device performs speech recognition by sending a spoken utterance to a remote computing system over a communication network, and receiving a result from the remote computing system indicative of a command included in the utterance.

17. A system comprising:
a processor of a vehicle, configured to
query a connected mobile device for available hardware services;
receive, from the mobile device, identifiers indicative of the available services;
identify identifiers corresponding to services supported by the vehicle computing platform;
send a list of the supported services to the mobile device; and
allow for user selection of the supported services on a human-machine interface (HMI) of the vehicle.

18. The system of claim 17, wherein the vehicle computing platform is further configured to:
offer, via the HMI of the vehicle, options for an internal speech recognition mode and an external speech recognition mode performed via a supported service of the mobile device;
responsive to the internal speech recognition mode being selected, performing speech recognition using the computing platform; and
responsive to the external speech recognition mode being selected, receiving processed speech recognition data from the mobile device.
